(19) United States
(12) Patent Application Publication
(10) Pub. No.: US 2007/0064036 A1
(43) Pub. Date: Mar. 22, 2007

(54) Information processing apparatus, association method

(75) Inventor: Kimitake Hasuike, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/333,220

(22) Filed: Jan. 18, 2006

(30) Foreign Application Priority Data
Aug. 18, 2005 (JP) P2005-237725

(51) Int. Cl. B41J 29/38

(52) U.S. Cl. 347/16

(57) ABSTRACT

An information processing apparatus includes a first information acquisition part, a second information acquisition part, and an information generation part. The first information acquisition part acquires first operation information with respect to an operation of a user on a first medium surface. The second information acquisition part acquires second operation information with respect to an operation of a user on a second medium surface. The information generation part generates associated information about the first medium surface and the second medium surface when there is a predetermined relation between the first operation information and the second operation information.

### CROSS-REFERENCE TO RELATED APPLICATIONS

This application is based on and claims the benefit of priority from the prior Japanese Patent Application No. 2005-237725, filed on Aug. 18, 2005; the entire contents of which are incorporated herein by reference.

### BACKGROUND OF THE INVENTION

1. Field of the Invention

The present invention relates to an information processing apparatus for processing information about a medium such as paper, and an association method etc. for associating information.

2. Description of the Related Art

A related art in which a character or a picture is drawn on special paper on which fine dots are printed and a user transmits data such as the character written on this paper to a personal computer or a cellular telephone, etc. and mail sending or retention of the contents of this data can be performed has received attention in recent years. This art is constructed so that small dots are printed on this special paper at a spacing of, for example, about 0.3 mm and all the dots draw different patterns every grid of, for example, a predetermined size. By reading this using a dedicated pen into Which, for example, a digital camera is built, a position of the character etc. written on this special paper can be pinpointed and such a character etc. can be used as electronic information.

Here, the related art for mutually binding information in different areas on such special paper. In this art, a hyper line having a discrete portion is generated by passing a pen through the boundary between areas having different coordinates. Then, a computer recognizes this hyper line, and mutually binds information in different areas, and assigns any attribute to the information, and executes action on the information, and also sends the information to a receiver.

As a natural act of a person, there is an act of taking a note by hand in a meeting, individual desk, etc. For example, it is an act of writing down a supplementary item on a document printed material handed out in a meeting. However, such a note is not necessarily taken on only the document printed material and may sometimes be taken over plural sheets of paper, for example, associated items are written on other document printed material or note paper. In such a case, it is necessary to retain the note written over plural sheets of paper as electronic information including the association in order to effectively use the note as electronic information.

However, the above-related at only discloses association between areas on a surface (hereinafter called “a medium surface”) of a medium such as paper, and does not provide concrete means for associating-medium surfaces mutually.

### SUMMARY OF THE INVENTION

The present invention has been made in view of the above circumstances and provides an information processing apparatus.

According to an aspect of the invention, an information processing apparatus includes a first information acquisition part, a second information acquisition part, and an information generation part. The first information acquisition part acquires first operation information with respect to an operation of a user on a first medium surface. The second information acquisition part acquires second operation information with respect to an operation of a user on a second medium surface. The information generation part generates associated information about the first medium surface and the second medium surface when there is a predetermined relation between the first operation information and the second operation information.

According to another aspect of the invention, an association method including: recognizing a first operation of a user on a first medium surface; recognizing a second operation of a user on a second medium surface; and storing associated information about the first medium surface and the second medium surface when there is a predetermined relation between the first operation and the second operation.

According to still another aspect of the invention, a storage medium is readable by a computer. The storage medium stores a program of instructions executable by the computer to perform a function for associating the function. The function includes acquiring first operation information with respect to an operation of a user on a first medium surface; acquiring second operation information with respect to an operation of a user on a second medium surface; and associating the first medium surface with the second medium surface when there is a predetermined relation between the first operation information and the second operation information.

### BRIEF DESCRIPTION OF THE DRAWINGS

Embodiments of the present invention will become more fully apparent from the following detailed description taken with the accompanying drawings in which:

FIG. 1 is a diagram showing a whole configuration of a system according to an embodiment;

FIG. 2 is a block diagram showing a functional configuration of an identification information management server according to the embodiment;

FIG. 3 is a diagram showing an example of the contents of a correspondence information DB according to the embodiment;

FIGS. 4A to 4C are diagrams describing a two-dimensional code image printed on a medium according to the embodiment;

FIG. 5 is a diagram showing a configuration example of a pen device according to the embodiment;

FIG. 6 is a flowchart showing an action of the pen device according to the embodiment;

FIG. 7 is a flowchart showing an action of division of locus information according to the embodiment;

FIG. 8 is a diagram showing an example of information every note unit according to the embodiment;

FIGS. 9A to 9C is a diagram describing an outline of a first example according to the embodiment;

FIG. 10 is a flowchart showing an action at the time of associated information generation in the first example of the embodiment;

FIG. 11 is a diagram showing an example of associated information generated in the first example of the embodiment;

FIGS. 12A to 12C are diagrams describing an outline of a second example of the embodiment;

FIG. 13 is a flowchart showing an action at the time of associated information generation and deletion in the second example of the embodiment;

FIG. 14 is a diagram showing an example of associated information generated in the second example of the embodiment; and

FIGS. 15A and 15B are diagrams showing another example of a display method of association between mutual media and mutual areas in the embodiment.

### DESCRIPTION OF THE EMBODIMENTS

The best mode (hereinafter called “an embodiment”) will be described below in detail with reference to the accompanying drawings.

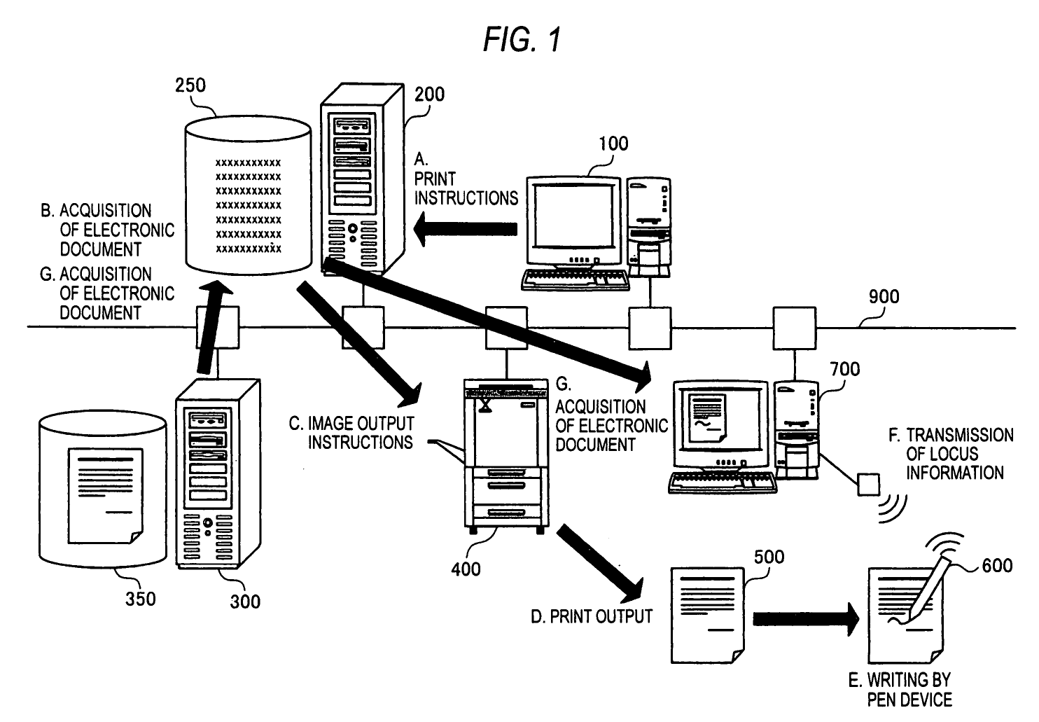

FIG. 1 shows one example of a configuration of a system to which the present embodiment is applied. At least a terminal apparatus 100 for instructing print of an electronic document or output of note paper, an identification information management server 200 for managing identification information assigned to a medium surface in the case of printing the electronic document or outputting the note paper and generating an image including a code image representing this identification information etc., a document management server 300 for managing the electronic document and an image formation apparatus 400 for printing the image generated by the identification information management server 200 on the medium surface are connected to a network 900 and thereby this system is configured.

Also, an identification information repository 250 acting as a storage device for storing the identification information is connected to the identification information management server 200, and a document repository 350 acting as a storage device for storing the electronic document is connected to the document management server 300.

Further, this system includes printed matter 500 outputted in the image formation apparatus 400, and a pen device 600 for recording a character or a figure on the printed matter 500 and reading a locus of the character or the figure. Also, a terminal apparatus 700 for superimposing and displaying the locus read by the pen device 600 on the electronic document as necessary is connected to the network 900.

An outline of an action of the present system will be described below.

The system is constructed so that a coded document printed material in which a code image is superimposed on a document image of an electronic document and coded note paper in which only a code image is printed on blank paper can be outputted.

Hence, the case of outputting the coded document printed material will be first described.

In this case, the terminal apparatus 100 instructs the identification information management server 200 to superimpose a code image on an image of an electronic document managed in the document repository 350 and do printing (A). At this time, print attributes such as a paper size, a direction, scaling, N-up (printing for allocating N pages of electronic documents inside one page of paper) or double-sided printing are also inputted from the terminal apparatus 100.

As a result of this, the identification information management server 200 acquires the electronic document whose printing is instructed from the document management server 300 (B). Then, a code image representing position information decided according to the print attributes and identification information managed in the identification information repository 250 is assigned to an image of the acquired electronic document and the image formation apparatus 400 is instructed to print its image (C). Incidentally, here, the identification information refers to information for uniquely identifying individual medium surfaces (papers) on which the image of the electronic document is printed, and the position information refers to information for pin pointing coordinates (X coordinate, Y coordinate) on the individual medium surfaces.

When print instructions are received from the identification information management server 200 thus, the image formation apparatus 400 outputs the coded document printed material as the printed matter 500(D).

Incidentally, though description will be made later in detail, the image formation apparatus 400 shall form the code image assigned in the identification information management server 200 using invisible toner in which an absorption factor of infrared light is higher than a predetermined criterion, and shall form the other images (images of a portion included in the original electronic document) using visible toner in which an absorption factor of infrared light is lower than a predetermined criterion.

On the other hand, it is assumed that a user records (writes) a character or a figure on the printed matter 500 using the pen device 600(E). As a result of this, the pen device 600 obtains position information and identification information about the printed matter 500 at regular time intervals. Concretely, the information is read by an infrared light detection function and an infrared light radiation function of the pen device 600.

Then, the pen device 600 transmits the identification information and locus information of the character or the figure obtained based on the position information to the terminal apparatus 700 by wireless or wire (F).

Thereafter, the terminal apparatus 700 sends identification information to the identification information management server 200 and thereby, requests sending of an electronic document corresponding to this identification information. When this request is received, the identification information management server 200 acquires the electronic document corresponding to the identification information from the document management server 300 and sends the electronic document to the terminal apparatus 700(G). As a result of that, the electronic document sent from the identification information management server 200 and the locus information obtained from the pen device 600 are combined and displayed in the terminal apparatus 700.

Next, the case of outputting the coded note paper will be described.

In this case, the terminal apparatus 100 instructs the identification information management server 200 to superimpose a code image on blank paper and do printing (A) At this time, print attributes such as a paper size, a direction, scaling, N-up (printing for allocating N pages of electronic documents inside one page of paper) or double-sided printing are also inputted from the terminal apparatus 100.

As a result of this, the identification information management server 200 instructs the image formation apparatus 400 to print only a code image including position information decided according to the print attributes and identification information managed in the identification information repository 250 without acquiring an electronic document from the document management server 300(C).

When print instructions are received from the identification information management server 200 thus, the image formation apparatus 400 outputs the coded note paper as the printed matter 500(D).

Incidentally, though description will be made later in detail, the image formation apparatus 400 shall form the code image assigned in the identification information management server 200 using invisible toner in which an absorption factor of infrared light is higher than a predetermined criterion.

On the other hand, it is assumed that a user records (writes) a character or a figure on the printed matter 500 using the pen device 600(E). As a result of this, the pen device 600 obtains position information and identification information about the printed matter 500 at regular time intervals. Concretely, the information is read by an infrared light detection function and an infrared light radiation function of the pen device 600.

Then, the pen device 600 transmits the identification information and locus information of the character or the figure obtained based on the position information to the terminal apparatus 700 by wireless or wire (F).

Thereafter, the terminal apparatus 700 displays a locus obtained from the pen device 600 without superimposing the locus on an electronic document. In that case, in the embodiment, when handwriting on the coded document printed material has a predetermined relation to handwriting on the coded note paper, these handwritten medium surfaces and areas are associated. That is, operation information with respect to writing by the pen device 600 is also sent from the terminal apparatus 700 to the identification information management server 200, and associated information about mutual medium surfaces is managed in the identification information management server 200.

Incidentally, when a handwritten note is only computerized, it is unnecessary to print identification information as a code image, but the embodiment is constructed so that identification information is also printed as a code image since the note paper is associated with the other printed matter 500.

The system to which the embodiment is applied has been described above, but such configuration and action are merely one example. For example, one server may be configured to have a function of the identification information management server 200 and a function of the document management server 300. Also, a function of the identification information management server 200 may be implemented by an image processing part (not shown) of the image formation apparatus 400. Further, the terminal apparatus 100 and 700 may be the same terminal apparatus.

Also, in the present specification, wording of an “electronic document” is used, but this does not refer to only data in which a “document” including text is computerized. For example, image data (which does not depend on raster data or vector data) such as a picture, a photograph or a figure, and other printable electronic data are also included to form the “electronic document”.

Each of the configurations included in this system will be described below in detail.

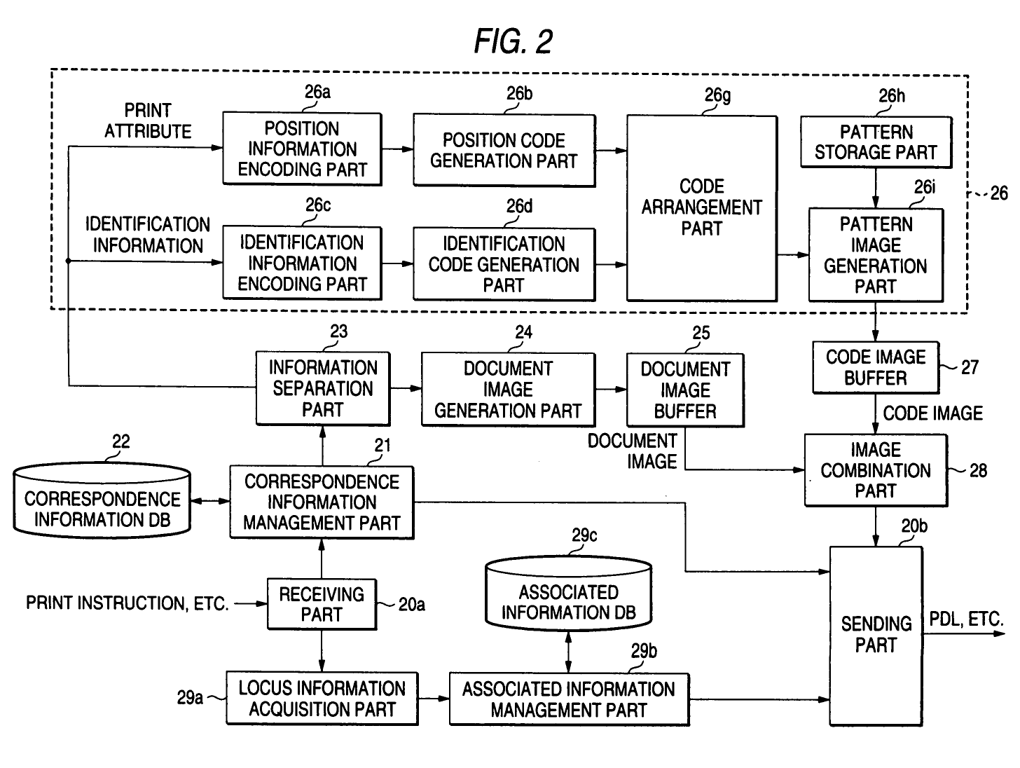

FIG. 2 is a diagram showing one example of a configuration of the identification information management server 200.

The identification information management server 200 comprises a receiving part 20a, a correspondence information management part 21, a correspondence information database (DD) 22, an information separation part 23, a document image generation part 24, a document image buffer 25, a code image generation part 26, a code image buffer 27, an image combination part 28, a locus information acquisition part 29a, an associated information management part 29b, an associated information DB 29c and a sending part 20b.

Also, the code image generation part 26 comprises a position information encoding part 26a, a position code generation part 26b, an identification information encoding part 26c, an identification code generation part 26d, a code arrangement part 26g, a pattern storage part 26h and a pattern image generation part 26i.

The receiving part 20a receives print instructions sent from the terminal apparatus 700, an electronic document sent from the document management server 300, locus information which is acquired by the pen device 600 and is sent from the terminal apparatus 700, etc. from the network 900.

The correspondence information management part 21 registers information (hereinafter called “correspondence information”) in which identification information (hereinafter called “a medium ID”) for identifying a medium surface is associated with identification information (hereinafter called “a page ID”) about a page of the original electronic document of an image printed on the medium surface in the correspondence information DB 22, or reads the information out of the correspondence information DB 22.

The correspondence information DB 22 is a database acting as a storage part for storing the correspondence information.

The information separation part 23 separates information passed from the correspondence information management part 21 into information necessary to generate a document image and information necessary to generate a code image.

Based on the information necessary to generate the document image separated by the information separation part 23, the document image generation part 24 images an electronic document and stores the electronic document in the document image buffer 25.

Based on the information necessary to generate the code image separated by the information separation part 23, the code image generation part 26 generates a code image and stores the code image in the code image buffer 27.

The image combination part 28 combines the document image stored in the document image buffer 25 with the code image stored in the code image buffer 27.

The locus information acquisition part 29a acquires locus information received by the receiving part 20a and records the locus information in memory (not shown). That is, this locus information acquisition part 29a can be grasped as a first information acquisition part from the standpoint of acquiring information with respect to an operation of a user on a first medium surface (for example, the coded document printed material). Also, it can be grasped as a second information acquisition part from the standpoint of acquiring information with respect to an operation of a user on a second medium surface (for example, the coded note paper).

The associated information management part 29b generates associated information about mutual medium surfaces based on the locus information recorded in this memory, and registers its associated information in the associated information DB 29c. Also, the associated information is read out of the associated information DB 29c. That is, this associated information management part 29b can be grasped as an information generation part from the stand point of generating the associated information.

The associated information DB 29c is a database acting as a storage part for storing the associated information.

The sending part 20b sends instructions to output an image after the combination by the image combination part 28 to the image formation apparatus 400 as a PDL (Page Description Language) typified by PostScript etc., or sends the instructed electronic document to the terminal apparatus 700.

The position information encoding part 26a encodes position information by a predetermined encoding method. In this encoding, for example, a BCH code or an RS (Reed Solomon) code which is a known error-correcting code can be used. Also, as an error-detecting code, a checksum value or a CRC (Cyclic Redundancy Check) of position information can be calculated to add it to the position information as a redundancy bit. Also, an M sequence code which is a kind of pseudo-noise sequence can be used as the position information. In the M sequence code, encoding is performed using a property in which a bit pattern generated in a partial sequence is generated in an M sequence only once when a partial sequence of a length P is fetched from an M sequence for an M sequence of P order (sequence length 2^{P-1}).

The position code generation part 26b converts the encoded position information into a format embedded as code information. For example, arrangement of each bit in the encoded position information can be encrypted or replaced by pseudo-random numbers etc. so that decryption by a third person becomes difficult. Also, when a position code is arranged in two dimensions, a bit value is arranged in two dimensions in a manner similar to arrangement of the code.

The identification information encoding part 26c encodes identification information by a predetermined encoding method when the identification information is inputted. In this encoding, a method similar to that used in encoding of the position information can be used.

The identification code generation part 26d converts the encoded identification information into a format embedded as code information. For example, arrangement of each bit in the encoded identification information can be encrypted or replaced by pseudo-random numbers etc. so that decryption by a third person becomes difficult. Also, when an identification code is arranged in two dimensions, a bit value is arranged in two dimensions in a manner similar to arrangement of the code.

The code arrangement part 26g combines the encoded identification information and the encoded position information arranged in the same format as that of the code, and generates a two-dimensional code array equivalent to an output image size. At this time, a code in which position information varying depending on an arrangement position is encoded is used as the encoded position information and a code in which the same information independently of a position is encoded is used as the encoded identification information.

The pattern image generation part 26i checks bit values of array elements in the two-dimensional code array, and acquires a bit pattern image corresponding to each of the bit values from the pattern storage part 26h, and outputs the bit pattern image as a code image in which the two-dimensional code array is imaged.

Incidentally, these function parts are implemented by cooperation between software and hardware resources. Concretely, a CPU (not shown) of the identification information management server 200 reads programs for implementing each of the functions of the receiving part 20a, the correspondence information management part 21, the information separation part 23, the document image generation part 24, the code image generation part 26, the image combination part 28, the locus information acquisition part 29a, the associated information management part 29b and the sending part 20b from an external storage device to a main storage device and performs processing.

Next, an action in the case that this identification information management server 200 sends instructions to output an image to the image formation apparatus 400 according to instructions from the terminal apparatus 100 will be described.

In the identification information management server 200, the receiving part 20a first receives print instructions from the terminal apparatus 100. The print instructions include a print mode of specifying which a coded document printed material or coded note paper is outputted, or print attributes such as a paper size, a direction, scaling, N-up or double-sided printing. Also, a document ID is included when an output of the coded document printed material is specified.

Here, the document ID refers to information for uniquely identifying an electronic document, and a URL (Uniform Resource Locator) which is address information about the electronic document can be used.

Incidentally, the print mode is not explicitly included in the print instructions, and it may be constructed so as to decide that it is instructions to output the coded document printed material when the document ID is included and it is instructions to output the coded note paper when the document ID is not included.

Next, the receiving part 20a passes the received information to the correspondence information management part 21.

As a result of this, the correspondence information management part 21 holds these information and also when there is a document ID, the document ID is passed to the sending part 20b and the sending part 20b is instructed to send an acquisition request for an electronic document corresponding to the document ID. The sending part 20b Which receives this instruction requests sending of the electronic document from the document management server 300.

In response to this sending request, the document management server 300 sends an electronic document of a print target to the identification information management server 200 and in the identification information management server 200, the receiving part 20a receives this electronic document and passes the electronic document to the correspondence information management part 21.

Subsequently, the correspondence information management part 21 fetches identification information used as a medium ID by the number of specified pages from the identification information repository 250 (see FIG. 1). Also, in the case of giving instructions to output the coded document printed material, information about correspondence between the medium ID and a page ID is registered in the correspondence information DB 22. In the case of giving instructions to output the coded note paper, only the medium ID is registered in the correspondence information DB 22.

Then, the correspondence information management part 21 outputs the medium ID, print attributes and a page image of an electronic document to the information separation part 23 in the case of giving instructions to output the coded document printed material. In the case of giving instructions to output the coded note paper, only the medium ID is outputted to the information separation part 23.

Thereafter, the information separation part 23 separates the passed information into information (medium ID and print attribute) necessary to generate a code and information (electronic document) necessary to generate a document image, and-outputs the former to the code image generation part 26 and outputs the latter to the document image generation part 24.

As a result of this, position information is encoded in the position information encoding part 26a, and a position code indicating the encoded position information is generated in the position code generation part 26b. Also, the medium ID is encoded in the identification information encoding part 26c, and an identification code indicating the encoded medium ID is generated in the identification code generation part 26d.

Then, a two-dimensional code array equivalent to an output image size is generated by the code arrangement part 26g, and a pattern image corresponding to the two-dimensional code array is generated by the pattern image generation part 26i.

On the other hand, the document image generation part 24 generates a document image of the electronic document.

Then, the document image generated by this document image generation part 24 and the code image previously generated by the code image generation part 26 are finally combined by the image combination part 28. However, when an output of the coded note paper is specified, the electronic document is not passed to the document image generation part 24, so that the document image is not accumulated in the document image buffer 25. Hence, when the document image is not accumulated in the document image buffer 25 within a certain time, the image combination part 28 generates a combined image from only code images accumulated in the code image buffer 27 and passes the combined image to the sending part 20b.

As a result of this, the sending part 20b sends instructions to output an image after the combination to the image formation apparatus 400.

In response to the instructions to output the image, the image formation apparatus 400 prints the combined image on a medium, and a user obtains the coded document printed material or the coded note paper as the printed matter 500.

The correspondence information DB 22 will be described herein.

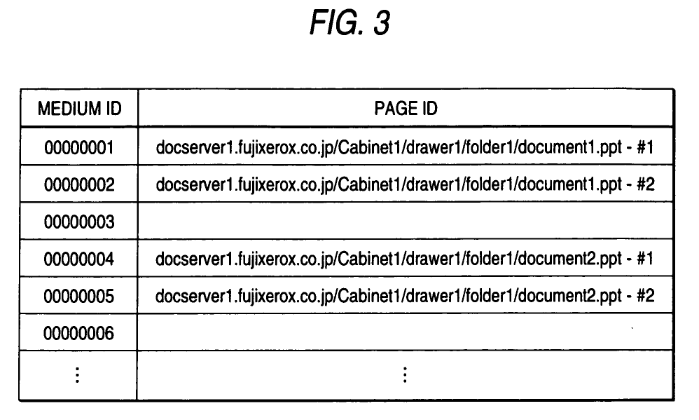

FIG. 3 is a diagram showing one example of the correspondence information DB 22.

As shown in the diagram, the correspondence information DB 22 associates a medium ID with a page ID and manages the IDs. The medium ID of these IDs is information for uniquely identifying a medium surface on which an electronic document is printed as described above. Also, the page ID is information for uniquely identifying a page of an electronic document. The page ID can be represented, for example, by joining a document ID (URL) to a page number as shown in the diagram.

By the way, in the embodiment, a page ID is not registered with respect to a medium ID assigned to coded note paper. Therefore, media of medium IDs “00000003” and “00000006” are found to be outputted as the coded note paper.

Incidentally, an action at the time of generating associated information by the identification information management server 200 will be described below.

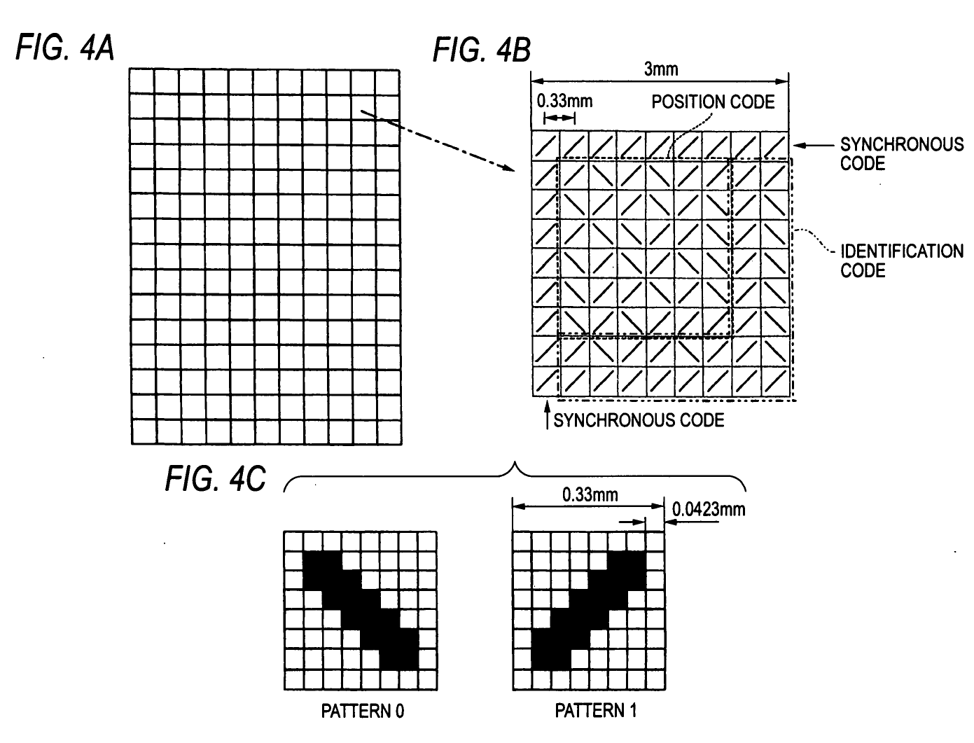

FIGS. 4A to 4C are diagrams describing a two-dimensional code image which is generated by the code image generation part 26 of the identification information management server 200 and is printed by the image formation apparatus 400. FIG. 4A is a diagram representing units of a two-dimensional code image arranged and formed by an invisible image in a grid shape in order to show the units schematically. Also, FIG. 4B is a diagram showing one unit of the two-dimensional code image in which the invisible image is recognized by infrared light radiation. Further, FIG. 4C is a diagram describing slash patterns of a backslash “\” and a slash “/”.

The two-dimensional code image formed by the image formation apparatus 400 is formed by, for example, invisible toner in which the maximum absorption factor in a visible light region (400 nm to 700 nm) is, for example, 7% or less and a absorption factor in a near-infrared region (800 nm to 1000 nm) is, for example, 30% or more. Also, this invisible toner whose average dispersion diameter is in the range of 100 nm to 600 nm is adopted in order to enhance a near-infrared light absorption capacity necessary for mechanical reading of an image. Here, “visibility” and “invisibility” do not depend on whether or not recognition can be made by a visual check. The “visibility” and “invisibility” are distinguished by a decision as to whether or not an image formed on a printed medium can be recognized by the presence or absence of color development properties resulting from absorption of a particular wavelength in a visible light region.

This two-dimensional code image shown in FIGS. 4A to 4C is formed by the invisible image in which processing of decoding and mechanical reading by infrared light radiation can be performed stably over the long term and information can be recorded at high density. Also, the invisible image is preferably an invisible image capable of being disposed in any area irrespective of an area in which a visible image of a medium surface to which an image is outputted is disposed. In the embodiment, the invisible image is formed on the whole surface of a medium surface (paper surface) according to a size of a medium printed. Also, the invisible image is further preferably, for example, an invisible image capable of being recognized by a gloss difference in the case of a visual check. However, “the whole surface” does not mean that all the four corners of paper are included. In an apparatus of an electrophotography method etc., there are many cases where the periphery of a paper surface is normally a range in which printing cannot be done, so that it is unnecessary to print the invisible image in such a range.

A two-dimensional code pattern shown in FIG. 4B includes an area in which a position code indicating a coordinate position on a medium is stored and an area in which an identification code for uniquely pinpointing a print medium is stored. Also, an area in which a synchronous code is stored is included. Then, as shown in FIG. 4A, a plurality of the two-dimensional code patterns are arranged, and two-dimensional codes in which different position information is stored in the whole surface of a medium surface (paper surface) according to a size of a medium printed are arranged in a grid shape. That is, a plurality of the two-dimensional code patterns as shown in FIG. 4B are arranged over the medium surface and each of the two-dimensional code patterns comprises the position code, the identification code and the synchronous code. Then, position information varying by places respectively arranged is stored in the areas of plural position codes. On the other hand, the same identification code is stored in the areas of plural identification codes regardless of places arranged.

In FIG. 4B, the position code is arranged in a rectangle area of 6 bits by 6 bits. Each of the bit values is formed by plural small line bit maps with different rotational angles, and a bit value 0 and a bit value 1 are represented by the slash patterns (pattern 0 and pattern 1) shown in FIG. 4C. More concretely, a bit 0 and a bit 1 are represented using a backslash “\” and a slash “/” having mutually different inclinations. The slash patterns are constructed by a size of 8 by 8 pixels and 600 dpi, and a rising slash pattern (pattern 0) from top left to bottom right represents the bit value 0 and a rising slash pattern (pattern 1) from bottom left to top right represents the bit value 1. Therefore, information (0 or 1) about 1 bit can be represented by one slash pattern. The two-dimensional code patterns in which noise applied to a visible image is small and a large amount of information can be digitized and embedded at high density can be provided by using such small line bit maps made of two kinds of inclinations.

That is, position information about a total of 36 bits is stored in the position code area shown in FIG. 4B. Of the 36 bits, 18 bits can be used in encoding of an X coordinate and 18 bits can be used in encoding of a Y coordinate. When all the respective 18 bits are used in encoding of the position, positions of 2¹⁸ ways (about 260,000 ways) can be encoded. When each of the slash patterns is constructed by 8 by 8 pixels (600 dpi) as shown in FIG. 4C, one dot of 600 dpi has 0.0423 mm, so that both the vertical and horizontal sizes of a two-dimensional code (including the synchronous code) of FIG. 4B become about 3 mm (8 pixels by 9 bits by 0.0423 mm). When positions of 260,000 ways are encoded at a spacing of 3 mm, a length of about 786 m can be encoded. Thus, all the 18 bits may be used in encoding of the positions, or a redundancy bit for error detection or error correction may be included when a detection error of the slash patterns occurs.

Also, the identification code is arranged in a rectangle area of 2 bits by 8 bits and 6 bits by 2 bits, and identification information about a total of 28 bits can be stored. When 28 bits are used as the identification information, identification information about 2²⁸ ways (about 270,000,000 ways) can be represented. In a manner similar to the position code, the identification code can also include a redundancy bit for error detection or error correction in 28 bits.

Incidentally, in the example shown in FIG. 4C, angles of the two slash patterns differ 90 degrees mutually, but four kinds of slash patterns can be constructed when an angle difference is 45 degrees. In the case of being constructed thus, information (0 to 3) about 2 bits can be represented by one slash pattern. That is, the number of bits capable of being represented can be increased by increasing a kind of angle of the slash pattern.

Also, in the example shown in FIG. 4C, encoding of the bit value has been described using the slash patterns, but patterns capable of being selected are not limited to the slash patterns. Methods for encoding by a direction in which a position of a dot is shifted from a reference position or ON/OFF of a dot can also be adopted.

Next, a method of association between mutual medium surfaces in the embodiment will be described concretely.

In the embodiment, the pen device 600 is used for association between mutual medium surfaces.

Hence, this pen device 600 will be first described in detail.

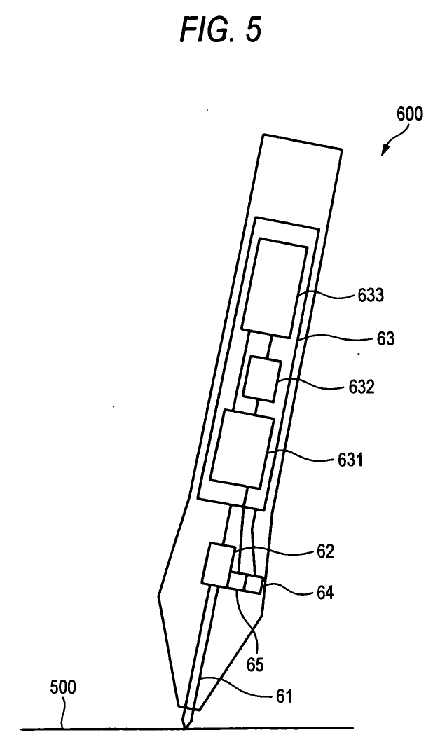

FIG. 5 is a diagram showing a configuration of the pen device 600.

This pen device 600 comprises a writing part 61 for recording a character or a figure on the printed matter 500 printed with and a document image combined by an operation similar to that of a normal pen, and a writing pressure detection part 62 for monitoring movement of the writing part 61 and detecting that the pen device 600 is pressed on paper. Also, the pen device 600 comprises a control part 63 for controlling the whole electronic action of the pen device 600, an infrared radiation part 64 for radiating paper with infrared light in order to read a code image on paper, and an image input part 65 for recognizing and inputting the code image by receiving the infrared light reflected.

Here, the control part 63 will be described in further detail.

The control part 63 comprises a code acquisition part 631, a locus calculation part 632 and an information storage part 633. The code acquisition part 631 is apart for analyzing an image inputted from the image input part 65 and acquiring a code. The locus calculation part 632 is a part for correcting a difference between a coordinate of the pen tip of the writing part 61 and a coordinate of an image captured by the image input part 65 with respect to the code acquired by the code acquisition part 631 and calculating a locus of the pen tip. The information storage part 633 is a part for storing the code acquired by the code acquisition part 631 or locus information calculated by the locus calculation part 632.

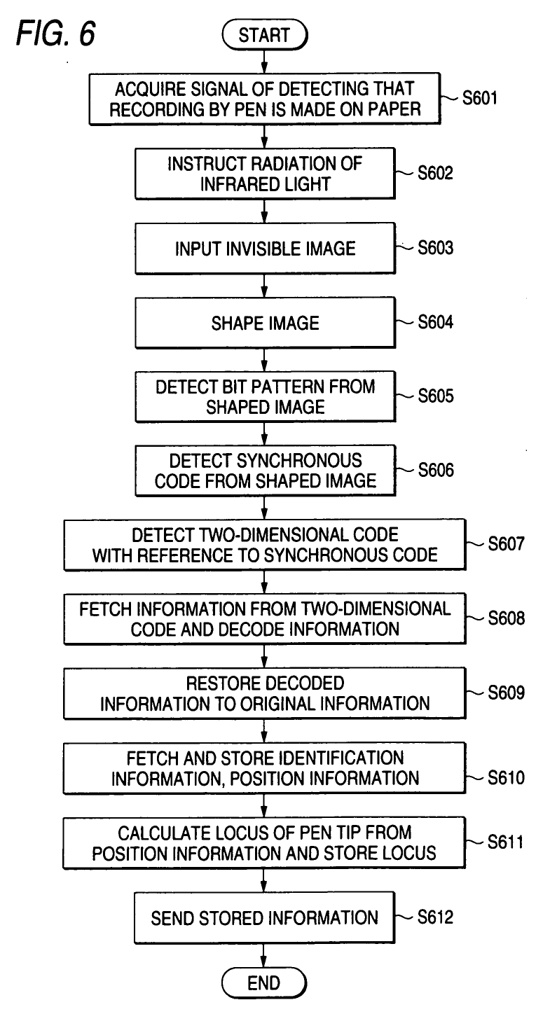

FIG. 6 is a flowchart showing processing mainly performed by the control part 63 of the pen device 600. When a character or a figure is recorded on, for example, paper using the pen device 600, the control part 63 acquires a signal of detecting that recording by a pen is made on the paper from the writing pressure detection part 62 (step 601). When this detection signal is detected, the control part 63 instructs the infrared radiation part 64 to radiate the paper with infrared light (step 602). The infrared light with which the paper is radiated by the infrared radiation part 64 is absorbed by an invisible image and is reflected by the other portions. In the image input part 65, this infrared light reflected is received and a portion in which the infrared light is not reflected is recognized as a code image. The control part 63 inputs (scans) this code image from the image input part 65 (step 603).

Thereafter, in the code acquisition part 631 of the control part 63, code image detection processing shown in step 604 to step 610 is performed. The code acquisition part 631 first shapes a scanned image inputted (step 604). Shaping of this scanned image is an inclination correction or noise elimination, etc. Then, bit patterns (slash patterns) of a slash “/” or a backslash “\”, etc. are detected from the scanned image shaped (step 605). Also, on the other hand, a synchronous code which is a code for two-dimensional code positioning is detected from the scanned image shaped (step 606). The code acquisition part 631 detects a two-dimensional code with reference to this synchronous code position (step 607). Also, information such an ECC (Error Correcting Code) is fetched from the two-dimensional code and is decoded (step 608). Then, the decoded information is restored to the original information (step 609).

In the code acquisition part 631 of the control part 63, position information and identification information are fetched from the code information restored in the above manner and the fetched information is stored in the information storage part 633 (step 610). On the other hand, the locus calculation part 632 calculates locus information (a row of correspondence between time and coordinates of the pen tip at that time) from the position information stored in the information storage part 633, and stores the locus information in the information storage part 633 (step 611). The identification information (medium ID) and the locus information stored in this information storage part 633 are sent to, for example, the terminal apparatus 700 by wire or wireless (step 612).

The terminal apparatus 700 receiving these information sends the medium ID and the locus information to the identification information management server 200.

As a result of this, in the identification information management server 200, the receiving part 20a receives the medium ID and the locus information. Then, these information is passed from the receiving part 20a to the locus information acquisition part 29a and in the locus information acquisition part 29a, processing in which a locus of pen tip on the printed matter 500 is divided into a note unit is performed. That is, the locus information sent from the pen device 600 does not necessarily correspond to a semantic division of a note and cannot be used in association between mutual median that state, so that the locus information is first divided into the note unit which is a semantic unity and is stored in memory.

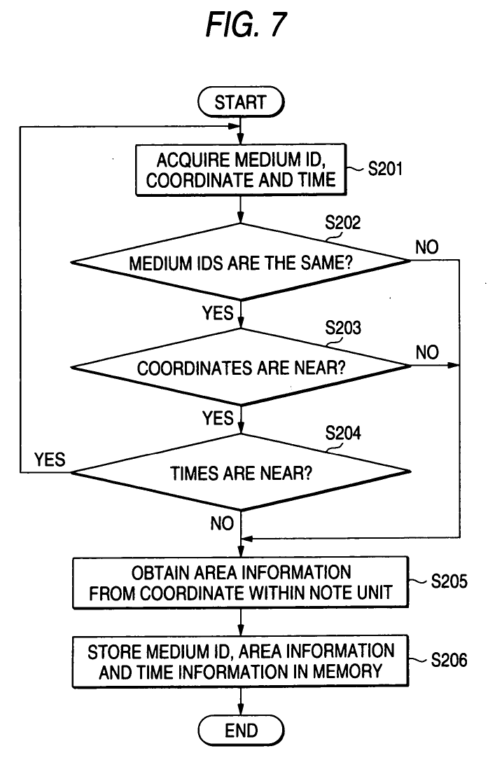

FIG. 7 is a flow chart showing a flow of division processing of a locus by the locus information acquisition part 29a.

First, the locus information acquisition part 29a acquires a medium ID, a coordinate and time from the receiving part 20a (step 201). That is, as described above, locus information is a row of correspondence between time and coordinates of the pen tip at that time, but cannot be used in association between media in that division state, so that it is acquired as correspondence between time and coordinates which are a smaller unit.

Next, the locus information acquisition part 29a determines whether or not medium IDs in information acquired this time and information acquired previous time are the same (step 202), and determines whether or not coordinates are near (step 203), and determines whether or not times are near (step 204). In other words, when handwritten positions are near and handwritten times are near in handwritings on the same medium surfaces, it is decided that this information constructs one note unit having a semantic relation to the previous information. However, a criterion in this decision is only one example, and other decision criteria may be adopted.

When all of these determination results become Yes, this information and the previous information are not divided and the flowchart returns to step 201 and the next information is acquired.

On the other hand, when any one of these determination results of steps 202 to 204 becomes No, the contents to the previous information are set as one note unit and the contents from this information are set as the next note unit. In that case, the locus information acquisition part 29a obtains area information for pinpointing an area of the note unit based on all the coordinates included in the note unit to the previous information (step 205). Incidentally, a method of obtaining the area information herein is not particularly limited and, for example, it is contemplated to obtain the maximum value Xmax, the minimum value Xmin of X coordinates, the maximum value Ymax and the minimum value Ymin of Y coordinates in all the coordinates and set a rectangle area surrounded by straight lines X=Xmax, X=Xmin, Y=Ymax and Y=Ymin as an area to be obtained.

Then, the locus information acquisition part 29a finally stores the medium IDs, area information and time information in memory (step 206). Here, the time information is information about a time range defined by the maximum value and the minimum value of the time included in the locus information divided.

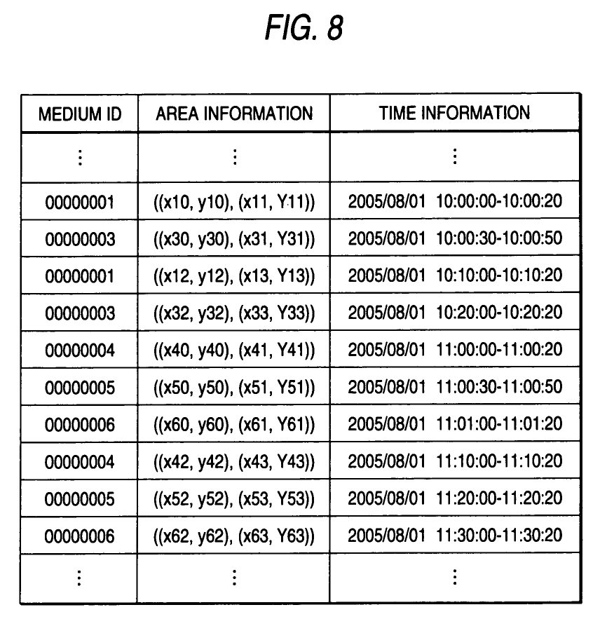

As described above, information as shown in FIG. 8 is accumulated in the memory.

In FIG. 8, correspondence among medium IDs, area information and time information is managed.

In this drawing, information about one note unit is recorded in one line. That is, the first four lines indicate that a note is made on a medium surface of a medium ID “00000001” and then a note is made on a medium surface of a medium ID “00000003” and a note is again made after returning to the medium surface of the medium ID “00000001” and then a note is made on the medium surface of the medium ID “00000003”.

Also, the area information is represented by coordinates of the upper left point and coordinates of the lower right point of a targeted area. For example, the first note unit shows that a note is made in an area in which coordinates of the upper left point are (x10, y10) and coordinates of the lower right point are (x11, y11).

Further, the time information indicates start time and end time of a note, and when the first note unit is taken as an example, it is indicated that a note is started at 10:00:00, Aug. 1, 2005 and the note is ended at 10:00:20, Aug. 1, 2005.

Incidentally, when locus information from plural pen devices 600 is unified by the identification information management server 200, it is necessary to also manage pen IDs for identifying the pen devices 600 normally, but in order to simplify description herein, only one pen device 600 is assumed and description of the pen ID is omitted.

After the locus information is divided into the note unit which is a semantic unity of a note thus, in the embodiment, the medium surfaces on which the notes are made are mutually associated in consideration of a relation between each of the note units.

Two examples will be described herein as a relation between the note units considered in that case.

First, a first example is an example in which when time at which a note is made on a coded document printed material is temporally near to time at which a note is made on coded note paper, these notes are considered as being mutually associated and the printed materials on which the notes are made are mutually associated.

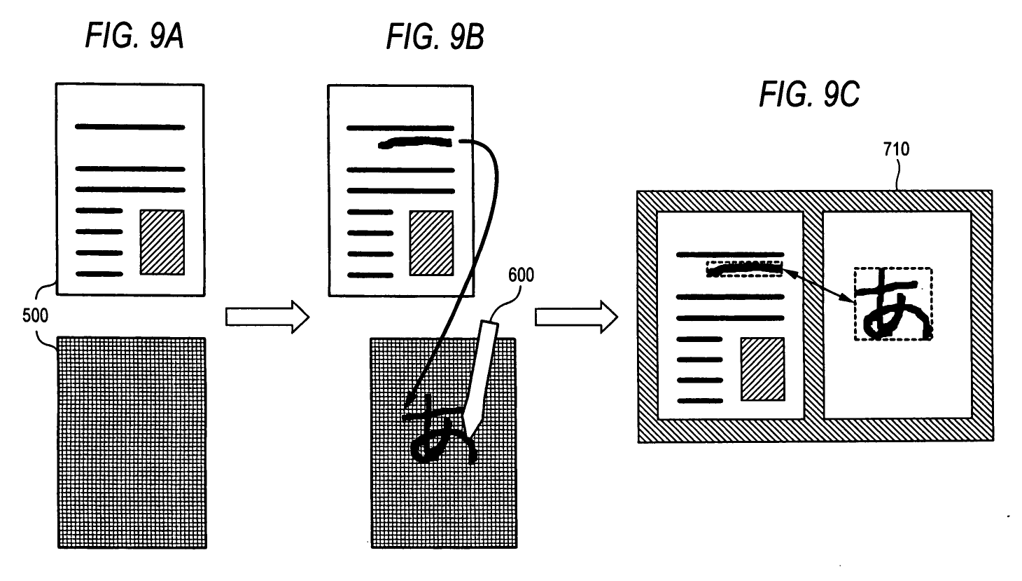

That is, first, as shown in FIG. 9A, a coded document printed material (upper side) in which a code image is superimposed on a document image and is printed, and coded note paper (lower side) in which a code image is printed on blank paper are outputted as the printed matter 500.

Hence, as shown in FIG. 9B, it is assumed that handwriting is performed on the coded document printed material and then handwriting is performed on the coded note paper within a certain time. “Δt” of FIG. 9B indicates shortness of time from the handwriting to the handwriting.

As a result of this, as shown in FIG. 9C, the coded document printed material and the coded note paper are associated and displayed on a screen 710 of the terminal apparatus 700. Incidentally, in that case, it may be constructed so as to perform display indicating association between areas including the associated note as shown in the drawing.

Processing of such association is performed by the associated information management part 29b of FIG. 2.

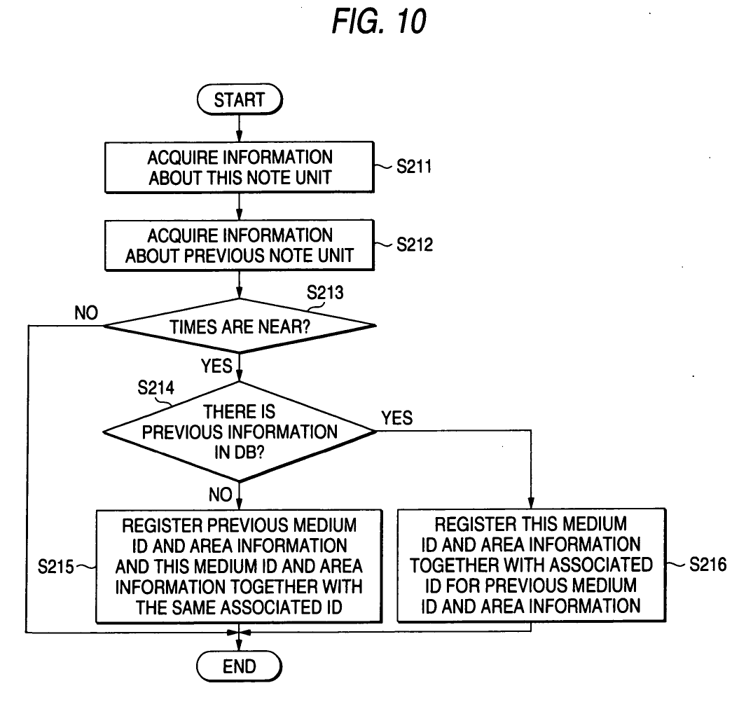

FIG. 10 is a flowchart showing an action of the associated information management part 29b.

First, the associated information management part 29b acquires information about a note unit recorded in memory this time (step 211). Also, information about a note unit recorded in memory previous time is acquired (step 212).

Then, it is determined whether or not times at which notes are made are near based on time information about this note unit and time information about previous note unit (step 213). Concretely, it is determined whether or not a time difference between the start time of a note in the former time information and the end time of a note in the latter time information is less than a predetermined threshold value.

When the time difference is the threshold value or more as a result of that, it is decided that a relation between these notes is small, and the processing is ended without performing association between the medium surfaces.

On the other hand, when the time difference is less than the threshold value, association between the medium surfaces is performed. Concretely, it is first determined whether or not an associated ID has already been assigned to area information and a medium ID in the previous note unit (step 214). When the associated ID has not been assigned therein, the same associated ID is associated with area information and a medium ID in the previous note unit and area information and a medium ID in this note unit and is registered in the associated information DB 29c (step 215). Also, when the associated ID has been assigned, its associated ID is associated with area information and a medium ID in this note unit and is registered in the associated information DB 29c (step 216).

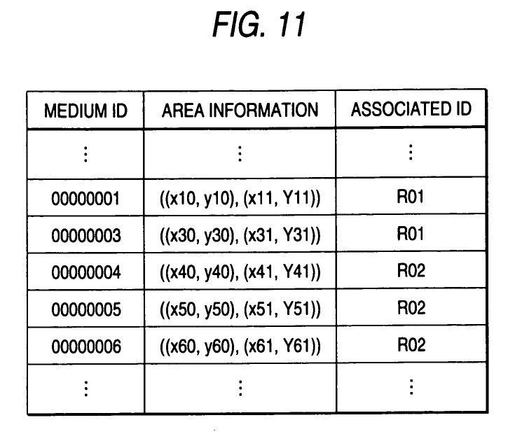

FIG. 11 is a diagram showing one example of the contents of the associated information DB 29c registered thus.

In this diagram, two sets of associated media and areas are defined by associated IDs “R01” and “R01”.

The associated ID “R01” of these associated IDs indicates that an area in which coordinates of the upper left point of a medium of a medium ID “00000001” are (x10, y10) and coordinates of the lower right point are (x11, y11) is associated with an area in which coordinates of the upper left point of a medium of a medium ID “00000003” are (x30, y30) and coordinates of the lower right point are (x31, y31). That is, when time ranging from the end time of a note with respect to the area in which coordinates of the upper left point of the medium of the medium ID “00000001” are (x10, y10) and coordinates of the lower right point are (x11, y11) to the start time of a note with respect to the area in which coordinates of the upper left point of the medium of the medium ID “00000003” are (x30, y30) and coordinates of the lower right point are (x31, y31) is 10 seconds and, for example, a threshold value is 30 seconds, these areas are associated. On the other hand, time ranging from the end time of a note with respect to an area in which coordinates of the upper left point of the medium of the medium ID ”00000001” are (x12, y12) and coordinates of the lower right point are (x13, y13) to the start time of a note with respect to an area in which coordinates of the upper left point of the medium of the medium ID “00000003” are (x32, y32) and coordinates of the lower right point are (x33, y33) is about 10 minutes, so that these areas are not associated.

Also, the associated ID “R02 indicates that an area in which coordinates of the upper left point of a medium of a medium ID” “00000004” are (x40, y40) and coordinates of the lower right point are (x41, y41), an area in which coordinates of the upper left point of a medium of a medium ID “00000005” are (x50, y50) and coordinates of the lower right point are (x51, y51), and an area in which coordinates of the upper left point of a medium of a medium ID “00000006” are (x60, y60) and coordinates of the lower right point are (x61, y61) are associated. Thus, the association is not limited to two medium surfaces and may be performed with respect to three or more medium surfaces.

Next, a second example is an example in which when the same special symbol (mark) is included in the contents of a note in a coded document printed material and the contents of a note in coded note paper, these notes are considered as being mutually associated and the printed materials on which the notes are made are mutually associated.

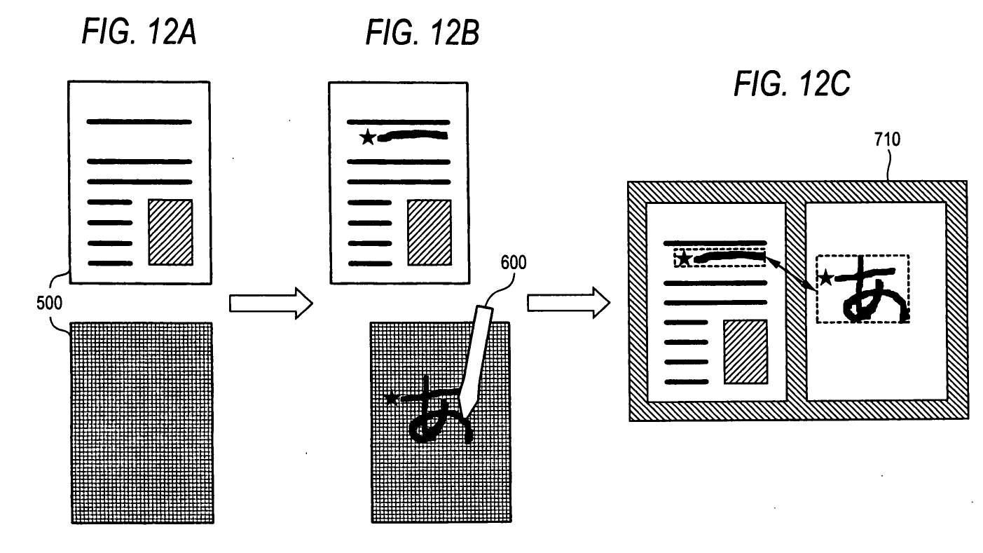

That is, first, as shown in FIG. 12A, a coded document printed material (upper side) in which a code image is superimposed on a document image and is printed, and coded note paper (lower side) in which a code image is printed on blank paper are outputted as the printed matter 500.

Hence, as shown in FIG. 12B, it is assumed that handwriting with a mark is performed on the coded document printed material and then handwriting with the same mark is also performed on the coded note paper. Here, as the mark, “*” is assigned to the head of the note. However, the mark is not limited to “★”, and any marks may be used as long as symbols used in the case of making a note in a normal manner are used. Typical marks include “*”, “※”, etc. Use of the marks used in the case of making a note in a normal manner thus has an advantage capable of performing association without performing a special operation. Incidentally, the mark for association may be a mark registered according to individual preference.

As a result of this, as shown in FIG. 12C, the coded document printed material and the coded note paper are associated and displayed on the screen 710 of the terminal apparatus 700. Incidentally, in that case, it maybe constructed so as to perform display indicating association between areas including the associated note as shown in the drawing.

Processing of such association is performed by the associated information management part 29b of FIG. 2.

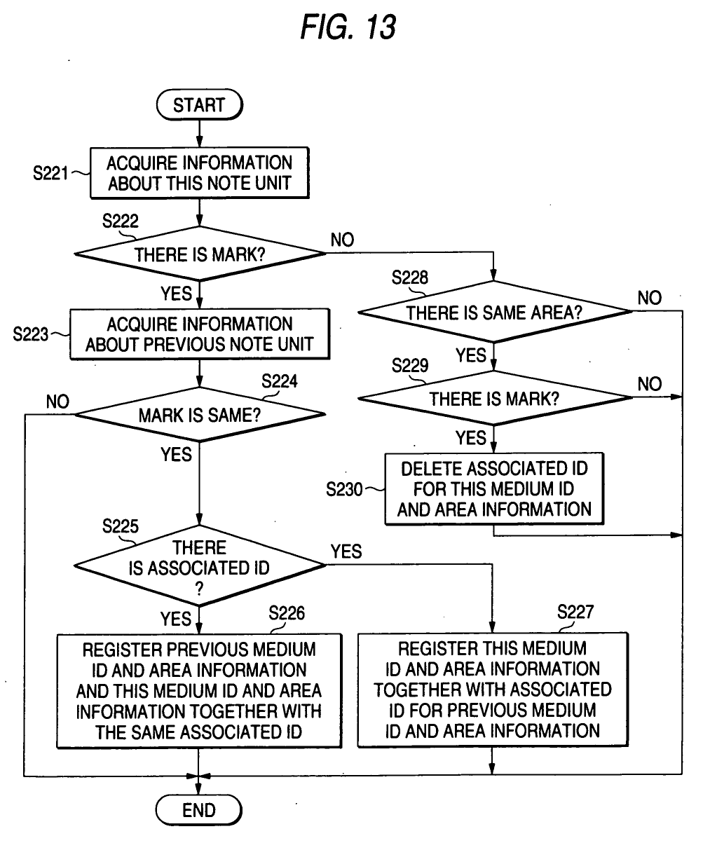

FIG. 13 is a flowchart showing an action of the associated information management part 29b. However, in this second example, the association can also be released by deleting any of the marks in the associated note or rewriting any of the marks to another mark. Hence, an action of such release of association is also included in FIG. 13.

First, the associated information management part 29b acquires information about a note unit recorded in memory this time (step 221).

Then, it is determined whether or not a predetermined mark is included in the contents of a note in this note unit (step 222). Incidentally, in FIG. 8, only the medium IDs, area information and time information are shown and, for example, an image actually written is stored in a storage place uniquely defined based on a medium ID and area information and thereby, it can be analyzed whether or not a mark is included in its image.

In the case of determining that the mark is included herein, information about a note unit recorded in the memory the previous time is acquired (step 223). Then, it is determined whether or not the mark in this note unit is the same as the mark in previous note unit (step 224).

When the mark is not same as a result of that, it is decided that a relation between these notes is small, and the processing is ended without performing association between the medium surfaces.

On the other hand, when the mark is same, association between the medium surfaces is performed. Concretely, it is first determined whether or not an associated ID has already been assigned to area information and a medium ID in the previous note unit (step 225). When the associated ID has not been assigned therein, the same associated ID is associated with area information and a medium ID in the previous note unit and area information and a medium ID in this note unit and is registered in the associated information DB 29c (step 226). Also, when the associated ID has been assigned, its associated ID is associated with area information and a medium ID in this note unit and is registered in the associated information DB 29c (step 227).

By the way, in the case of determining that the mark is not present in step 222, the case that the mark is not present originally and the case that the mark which has originally been present is deleted are considered. These cases are properly decided by the following action and association is also released.

That is, the associated information management part 29b retrieves a note unit of the same area of the same medium surface as this note unit, and determines whether or not there is such a note unit (step 228).

When there is not such a note unit as a result of that, it can be decided that this note unit is a note unit first performed in the area and a mark is not assigned since association is not intended, so that the processing is ended as it is.

On the other hand, when there is such a note unit, it is determined whether or not a mark is included in the contents of a note in its note unit (step 229). When the mark is not present, since the mark is not present the previous time and the mark is not present this time, it can be decided that association is not intended, so that the processing is ended as it is. Also, when the mark is present, the previous mark is deleted or rewritten by this note unit, so that association is released. Concretely, an associated ID corresponding to area information and a medium ID in this note unit is deleted in the associated information DB 29c (step 230).

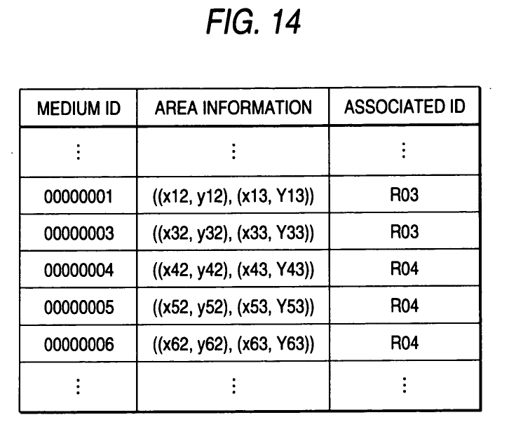

FIG. 14 is a diagram showing one example of the contents of the associated information DB 29c registered thus.

In this diagram, two sets of associated media and areas are defined by associated IDs “R03” and “R04”.

That is, the associated ID “R03” indicates that an area in which coordinates of the upper left point of a medium of a medium ID “00000001” are (x12, y12) and coordinates of the lower right point are (x13, y13) is associated with an area in which coordinates of the upper left point of a medium of a medium ID “00000003” are (x32, y32) and coordinates of the lower right point are (x33, y33). That is, time ranging from the end time of a note with respect to the area in which coordinates of the upper left point of the medium of the medium ID “00000001” are (x12, y12) and coordinates of the lower right point are (x13, y13) to the start time of a note with respect to the area in which coordinates of the upper left point of the medium of the medium ID “00000003” are (x32, y32) and coordinates of the lower right point are (x33, y33) is about 10 minutes and when the same note is written into the notes of these areas, the association is performed thus.

Also, the associated ID “R04 indicates that an area in which coordinates of the upper left point of a medium of a medium ID “00000004” are (x42, y42) and coordinates of the lower right point are (x43, y43), an area in which coordinates of the upper left point of a medium of a medium ID “00000005” are (x52, y52) and coordinates of the lower right point are (x53, y53), and an area in which coordinates of the upper left point of a medium of a medium ID “00000006” are (x62, y62) and coordinates of the lower right point are (x63, y63) are associated. Thus, the association is not limited to two medium surfaces and may be performed with respect to three or more medium surfaces.

Now, in a display method of a result of associating mutual medium surfaces, the example of performing display in a form of arranging and displaying the medium surfaces and seeing the associated areas has been shown in FIG. 9C or FIG. 12C.

However, several display methods other than this example are contemplated.

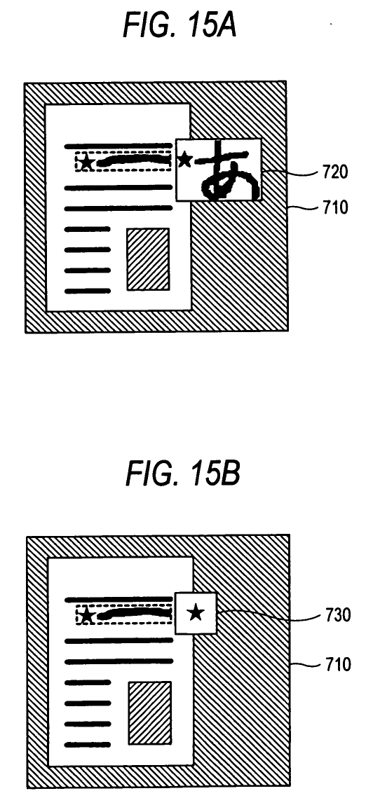

FIG. 15A and 15B show examples of such display methods.

FIG. 15A is an example in which an image on one medium (for example, a coded document printed material) associated is displayed and only an associated area 720 of the other medium surface is displayed in the vicinity of the associated area.

FIG. 15B is an example in which an image on one medium (for example, a coded document printed material) associated is displayed and a sign 730 only indicating that the associated area is present is displayed in the vicinity of the associated area. In this case, it can also be constructed so as to display the associated area of the other associated medium surface by, for example, clicking the sign 730 by a mouse.

Thus, in the embodiment, a user performs a predetermined operation using, for example, a pen device on medium surfaces to which identification information is allocated without having awareness of association and thereby, the medium surfaces can be associated.

Incidentally, in the embodiment, it has been constructed so as to associate the medium surfaces mutually by performing writing on the medium surfaces using the pen device, but it is not limited to such a form. That is, the medium surfaces can also be mutually associated by various operations other than the writing, for example, operations of only hitting or tracing on the medium surfaces.

Also, in the embodiment, it has been constructed so as to associate the medium surfaces mutually by the identification information management server, but this is not limited to such a form. For example, there may be a form in which a pen device acquiring operation information about medium surfaces associates the medium surfaces and sends the information to another computer.

Also, in the embodiment, it has been constructed so as to always associate areas mutually in the case of associating media mutually, but the association between the mutual medium surfaces will do sufficiently and the association between the mutual areas is not necessarily performed.

As described above, according to an aspect of the invention, an information processing apparatus comprises: a first information acquisition part that acquires first operation information with respect to an operation of a user on a first medium surface, a second information acquisition part that acquires second operation information with respect to an operation of a user on a second medium surface, and an information generation part that generates associated information about the first medium surface and the second medium surface when there is a predetermined relation between the first operation information and the second operation information.

According to another aspect of the invention, in the information processing apparatus, the predetermined relation is a relation in which time of the operation of the user on the first medium surface is temporally near to time of the operation of the user on the second medium surface.

According to another aspect of the present invention, in the information processing apparatus, the predetermined relation is a relation in which both of a first descriptive content by the operation of the user on the first medium surface and the second descriptive content by the operation of the user on the second medium surface include a special symbol.

According to another aspect of the present invention, in the information processing apparatus, the information generation part deletes the associated information about the first medium surface and the second medium surface when either one of the first descriptive content and the second descriptive content does not include the special symbol.

According to another aspect of the invention, in the information processing apparatus, the first information acquisition part acquires a first identification information for identifying the first medium surface according to the operation of the user on the first medium surface, wherein the second information acquisition part acquires a second identification information for identifying the second medium surface according to the operation of the user on the second medium surface, and wherein the information generation part generates information for associating the first identification information with the second identification information as the associated information.

According to another aspect of the invention, in the information processing apparatus, a code image representing the first identification information is formed on the first medium surface, and a code image representing the second identification information is formed on the second medium surface.

According to another aspect of the invention, in the information processing apparatus, a document image and the code image representing the first identification information are formed on the first medium surface, wherein a code image representing the second identification information is formed on the second medium surface, and wherein a document image is not formed on the second medium surface.

According to another aspect of the invention, in the information processing apparatus, the first information acquisition part further acquires first area information indicating a first area in which an operation on the first medium surface is performed according to the operation of the user on the first medium surface, wherein the second information acquisition part further acquires second area information indicating a second area in which an operation on the second medium surface is performed according to the operation of the user on the second medium surface, and wherein the information generation part generates information for further associating the first area information with the second area information as the associated information.

According to another aspect of the invention, the information processing apparatus further comprises: a display part that displays the first medium surface and the second medium surface in a form of seeing association between the first area and the second area.

According to another aspect of the invention, the information processing apparatus further comprises: a display part that displays the first medium surface and displaying the second area in a vicinity of the first area.

According to another aspect of the invention, the information processing apparatus further comprises: a display part that displays the first medium surface and displaying a sign indicating a presence of the second area in a vicinity of the first area and displaying said second area according to a predetermined operation on said sign.

According to another aspect of the invention, an association method comprises: recognizing a first operation of a user on a first medium surface; recognizing a second operation of a user on a second medium surface; and storing associated information about the first medium surface and the second medium surface when there is a predetermined relation between the first operation and the second operation.

According to another aspect of the invention, in the association method, the predetermined relation is a relation in which time of the first operation is temporally near to time of the second operation.

According to another aspect of the invention, in the association method, the predetermined relation is a relation in which both of the first descriptive contents by the first operation and the second descriptive contents by the second operation include a special symbol.

According to another aspect of the invention, the association method further comprises: acquiring first identification information for identifying the first medium surface according to the first operation; acquiring second identification information for identifying the second medium surface according to the second operation; and storing information for associating the first identification information with the second identification information as the associated information, when the associated information about the first medium surface and the second medium surface is stored.

According to another aspect of the invention, the association method further comprises: acquiring first area information indicating a first area in which said first operation is performed according to the first operation, and acquiring second area information indicating a second area in which said second operation is performed according to the second operation, characterized in that in the step of storing, information for further associating the first area information with the second area information is stored as the associated information.

According to another aspect of the invention, the association method further comprises: displaying the first medium surface and the second medium surface in a form of seeing association between the first area and the second area.

According to another aspect of the invention, a storage medium is readable by a computer, the storage medium stores a program of instructions executable by the computer to perform a function for associating, and the function comprises: acquiring first operation information with respect to an operation of a user on a first medium surface; acquiring second operation information with respect to an operation of a user on a second medium surface; and associating the first medium surface with the second medium surface when there is a predetermined relation between the first operation information and the second operation information.

According to another aspect of the invention, in the storage medium readable by a computer, the predetermined relation is a relation in which time of an operation of a user on the first medium surface is temporally near to time of the operation of the user on the second medium surface.

According to another aspect of the invention, in the storage medium readable by a computer, the predetermined relation is a relation in which both of the first descriptive contents by an operation of a user on the first medium surface and the second descriptive contents by an operation of a user on the second medium surface include a special symbol.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined solely by the following claims and their equivalents.

What is claimed is:

1. An information processing apparatus comprising:
a first information acquisition part that acquires first operation information with respect to an operation of a user on a first medium surface,
a second information acquisition part that acquires second operation information with respect to an operation of a user on a second medium surface, and
an information generation part that generates associated information about the first medium surface and the second medium surface when there is a predetermined relation between the first operation information and the second operation information.

2. An information processing apparatus as claimed in claim 1, wherein the predetermined relation is a relation in which time of the operation of the user on the first medium surface is temporally near to time of the operation of the user on the second medium surface.

3. An information processing apparatus as claimed in claim 1, wherein the predetermined relation is a relation in which both of a first descriptive content by the operation of the user on the first medium surface and the second descriptive content by the operation of the user on the second medium surface include a special symbol.

4. An information processing apparatus as claimed in claim 3, wherein the information generation part deletes the associated information about the first medium surface and the second medium surface when either one of the first descriptive content and the second descriptive content does not include the special symbol.

5. An information processing apparatus as claimed in claim 1, wherein the first information acquisition part acquires a first identification information for identifying the first medium surface according to the operation of the user on the first medium surface,
wherein the second information acquisition part acquires a second identification information for identifying the second medium surface according to the operation of the user on the second medium surface, and
wherein the information generation part: generates information for associating the first identification information with the second identification information as the associated information.

6. An information processing apparatus as claimed in claim 5, wherein a code image representing the first identification information is formed on the first medium surface, and
a code image representing the second identification information is formed on the second medium surface.

7. An information processing apparatus as claimed in claim 5, wherein a document image and the code image representing the first identification information are formed on the first medium surface,
wherein a code image representing the second identification information is formed on the second medium surface, and
wherein a document image is not formed on the second medium surface.

8. An information processing apparatus as claimed in claim 5, wherein the first information acquisition part further acquires first area information indicating a first area in which an operation on the first medium surface is performed according to the operation of the user on the first medium surface,
wherein the second information acquisition part further acquires second area information indicating a second area in which an operation on the second medium surface is performed according to the operation of the user on the second medium surface, and
wherein the information generation part generates information for further associating the first area information with the second area information as the associated information.

9. An information processing apparatus as claimed in claim 8, further comprising:
a display part that displays the first medium surface and the second medium surface in a form of seeing association between the first area and the second area.

10. An information processing apparatus as claimed in claim 8, further comprising:
a display part that displays the first medium surface and displaying the second area in a vicinity of the first area.

11. An information processing apparatus as claimed in claim 8, further comprising:
a display part that displays the first medium surface and displaying a sign indicating a presence of the second area in a vicinity of the first area and displaying said second area according to a predetermined operation on said sign.

12. An association method comprising:
recognizing a first operation of a user on a first medium surface;
recognizing a second operation of a user on a second medium surface; and
storing associated information about the first medium surface and the second medium surface when there is a predetermined relation between the first operation and the second operation.

13. An association method as claimed in claim 12, wherein the predetermined relation is a relation in which time of the first operation is temporally near to time of the second operation.

14. An association method as claimed in claim 12, wherein the predetermined relation is a relation in which both of the first descriptive contents by the first operation and the second descriptive contents by the second operation include a special symbol.

15. An association method as claimed in claim 12, further comprising:
acquiring first identification information for identifying the first medium surface according to the first operation;
acquiring second identification information for identifying the second medium surface according to the second operation; and
storing information for associating the first identification information with the second identification information as the associated information, when the associated information about the first medium surface and the second medium surface is stored.

16. An association method as claimed in claim 15, further comprising:
acquiring first area information indicating a first area in which said first operation is performed according to the first operation, and acquiring second area information indicating a second area in which said second operation is performed according to the second operation, characterized in that in the step of storing, information for further associating the first area information with the second area information is stored as the associated information.

17. An association method as claimed in claim 16, further comprising:
displaying the first medium surface and the second medium surface in a form of seeing association between the first area and the second area.

18. A storage medium readable by a computer, the storage medium storing a program of instructions executable by the computer to perform a function for associating, the function, comprising:
acquiring first operation information with respect to an operation of a user on a first medium surface;
acquiring second operation information with respect to an operation of a user on a second medium surface; and
associating the first medium surface with the second medium surface when there is a predetermined relation between the first operation information and the second operation information.

19. A storage medium readable by a computer as claimed in claim 18, wherein the predetermined relation is a relation in which time of an operation of a user on the first medium surface is temporally near to time of the operation of the user on the second medium surface.

20. A storage medium readable by a computer as claimed in claim 18, wherein the predetermined relation is a relation in which both of the first descriptive contents by an operation of a user on the first medium surface and the second descriptive contents by an operation of a user on the second medium surface include a special symbol.
